(19) United States
(12) Patent Application Publication
(10) Pub. No.: US 2026/0211666 A1
(43) Pub. Date: Jul. 23, 2026

(54) MANAGING SOURCE CODE CHANGES BASED ON CHANGE CHARACTERISTICS

(71) Applicant: Dell Products L.P., Round Rock, TX (US)

(72) Inventors: BORIS SHPILYUCK, Ashdod (IL); YONIT LOPATINSKI, Shomria (IL); OR HERMAN SAFFAR, Ofakim (IL); JEHUDA SHEMER, Kfar Saba (IL)

(21) Appl. No.: 19/032,957

(22) Filed: Jan. 21, 2025

(51) Int. Cl. G06F 8/71; G06F 8/10

(52) U.S. Cl. CPC G06F 8/71; G06F 8/10

(57) ABSTRACT

Methods and systems for providing computer-implemented services using a data processing system are disclosed. To provide the computer-implemented services, a set of changes for a codebase may be obtained. Using the set of changes, an analysis process may be performed to obtain change characteristics for the set of changes. A review process may be performed based on the change characteristics to determine whether the set of changes is to be integrated into the codebase. If the set of changes is to be integrated into the codebase, an integration process may be performed to continue provision of the computer-implemented services.

### FIELD

Embodiments disclosed herein relate generally to managing source code changes. More particularly, embodiments disclosed herein relate to systems and methods to manage source code changes based on change characteristics.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show diagrams illustrating data flows in accordance with an embodiment.

FIGS. 3A-3C show flow diagrams illustrating a method for providing computer-implemented services in accordance with an embodiment.

FIG. 4 shows a block diagram illustrating a data processing system in accordance with an embodiment.

### DETAILED DESCRIPTION

Various embodiments will be described with reference to details

discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using a data processing system. The data processing system may be used by a business, individual, and/or any other downstream consumer of the computer-implemented services. To provide the computer-implemented services to the downstream consumer, the data processing system may include any number of hardware components, such as processors, memory modules, storage devices, communication devices, etc. The hardware components of the data processing system may support execution of any number and/or type of software components (e.g., software programs). Changes in available functionalities of the hardware components and/or the software components of the data processing system may provide for various types of different computer-implemented services to be provided to the downstream consumer.

Over time, the software components of the data processing system may be modified. For example, a software program hosted by the data processing system may be updated to improve performance of the data processing system, add functionality to the data processing system, reduce a security risk associated with the software program, etc. Updates and/or other modifications made to the software components of the data processing system may allow for additional computer-implemented services to be provided, more reliable computer-implemented services to be provided, the computer-implemented services to be provided in a more secure manner, and/or other improvements to the computer-implemented services provided to the downstream consumer.

The software components of the data processing system may be modified by integrating a set of changes to source code for a software program into a codebase. However, integrating the set of changes into the codebase may have undesired impacts on the software program. For example, the set of changes may introduce bugs and/or errors into the software program, reduce maintainability of the software program, introduce compatibility and/or performance issues, introduce security issues (e.g., introduce new security vulnerabilities and/or expose existing security vulnerabilities), and/or result in other undesired impacts on the software program. Consequently, the computer-implemented services provided to the downstream consumer using the software program may be delayed, provided in a manner that does not meet the expectations of the downstream consumer, and/or may otherwise be negatively impacted.

To reduce a likelihood of errors being introduced into the codebase and/or other undesired impacts on the functionality of the software program, the set of changes may be analyzed prior to integrating the set of changes into the codebase to obtain change characteristics for the set of changes. The change characteristics may include: (i) a change magnitude for the set of changes, (ii) a subject for at least a portion of the set of changes, (iii) upstream dependencies for functionalities of the software program that would be modified should the set of changes be integrated into the codebase, and/or (iv) other characteristics for the set of changes.

Obtaining the change magnitude for the set of changes may include obtaining a criticality value and a similarity value for the set of changes. The criticality value may indicate a degree of impact of integrating the set of changes into the codebase (e.g., based on a number of application programming interfaces (APIs) of an API call chain impacted by the set of changes). The similarity value may indicate a degree of similarity between the source code before and the source code after the integration of the set of changes into the codebase (e.g., based on changes in functionality of the software program and/or other similarity metrics). The change magnitude may be calculated as a weighted sum of the criticality value and the similarity value for the set of changes.

A review process may be performed for the set of changes based on the change characteristics to determine whether the set of changes is to be integrated into the codebase. Performing the review process may include obtaining a reviewing pipeline for the set of changes, the reviewing pipeline indicating entities (e.g., reviewers) that are to perform portions of the review process, and an ordering between the portions of the review process (e.g., an order in which each of the reviewers is to perform their portion of the review process). Outcomes of the portions of the review process may indicate whether the set of changes is to be integrated into the codebase.

Thus, embodiments disclosed herein may address, among other technical problems, the technical challenge of integrating sets of changes into codebases. By managing integration of a set of changes into a codebase for a software program using change characteristics for the set of changes, a likelihood of errors being introduced into the codebase and/or other undesired impacts on the functionality of the software program may be reduced. Consequently, a likelihood of providing the computer-implemented services using the software program in a manner that meets the expectations of a downstream consumer of the computer-implemented services may be improved.

In an embodiment, a method for providing computer-implemented services using a data processing system is disclosed. The method may include: obtaining a set of changes for a codebase from an entity, the codebase including source code for a software program, and the set of changes including potential changes to the source code usable to obtain an updated version of the software program; performing, using the set of changes, an analysis process to obtain change characteristics for the set of changes, the change characteristics including: a change magnitude for the set of changes, a subject for at least a portion of the set of changes, and upstream dependencies for functionalities of the software program that would be modified should the set of changes be integrated into the codebase; performing a review process for the set of changes to determine whether the set of changes is to be integrated into the codebase, the review process being based on the change characteristics; and in a first instance of the performing in which the set of changes is to be integrated into the codebase: performing an integration process to obtain the updated version of the software program to continue provision of the computer-implemented services.

Performing the review process may include: obtaining a reviewing pipeline for the set of changes, the reviewing pipeline indicating entities that are to perform portions of the review process, an ordering between the portions of the review process, and outcomes of the portion of the review process indicating whether the set of changes is to be integrated into the codebase.

Performing the review process may include: initiating review of the set of changes using the reviewing pipeline to obtain the outcomes, the outcomes indicating whether corresponding portions of the source code as modified by the set of changes meet functional specification requirements for the updated version of the software program; and determining whether to integrate the set of changes into the codebase using the outcomes.

Obtaining the reviewing pipeline may include: identifying, based on the subject for the at least the portion of the set of changes and/or the upstream dependencies, a portion of reviewers that are qualified to review the set of changes; and selecting, based on at least reviewer characteristics for the reviewers and the change magnitude for the set of changes, at least one reviewer from the portion of reviewers for inclusion in the reviewing pipeline.

Selecting the at least one reviewer may include: identifying, based on the change characteristics, entity characteristics for the entity, and a reviewer rule set, reviewer requirements for the set of changes; and selecting, from the portion of reviewers and based on the reviewer characteristics, the at least one reviewer that meets the reviewer requirements for the set of changes.

A higher change magnitude may indicate integrating the set of changes into the codebase has an increased risk of undesired impacts on the updated version of the software program, and mitigating the increased risk of undesired impacts may result in a larger resource consumption to meet the reviewer requirements.

The at least one reviewer may include a team of reviewers that, in aggregate, meets the reviewer requirements for the set of changes, and the team of reviewers may include a subject matter expert (SME).

The team of reviewers may include at least one fully automated entity.

The reviewer characteristics may include at least one type of characteristic selected from a list consisting of: reviewer job ranking; reviewer experience level; and reviewer area of expertise.

Performing the analysis process may include: performing a first analysis process to obtain the change magnitude for the set of changes, the change magnitude indicating a level of change to the source code should the set of changes be integrated into the codebase; performing a second analysis process to obtain the subject for the at least a portion of the set of changes; and performing a third analysis process to obtain the upstream dependencies for the functionalities of the software program that would be modified should the set of changes be integrated into the codebase.

Performing the first analysis process may include: obtaining, using the set of changes and the codebase, a criticality value for the set of changes; obtaining, using the set of changes and the codebase, a similarity value for the set of changes; and obtaining, using at least the criticality value and the similarity value, the change magnitude.

Obtaining the criticality value may include: evaluating a degree of impact of integrating the set of changes into the codebase, the degree of impact being based on a number of application programming interfaces (APIs) impacted by the set of changes; and assigning, based on the degree of impact, the criticality value.

Obtaining the similarity value may include: obtaining, using the set of changes and a trained machine learning model, a first summary of the set of changes and a second summary of at least a portion of the source code that would be impacted by integrating the set of changes into the codebase; comparing the first summary and the second summary to obtain a difference; and assigning, based on the difference, the similarity value.

The change magnitude may be a weighted sum of the criticality value and the similarity value.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

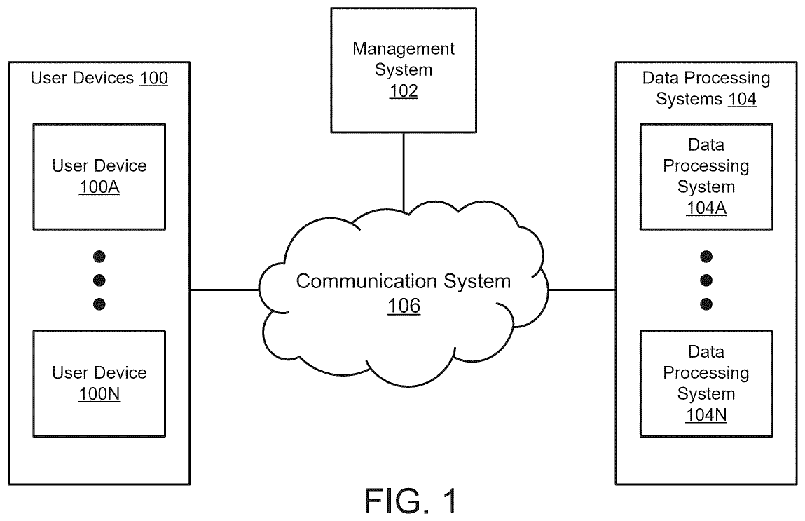

Turning to FIG. 1, a block diagram illustrating a system in accordance with an embodiment is shown. The system shown in FIG. 1 may provide computer-implemented services. The computer implemented services may include any type and quantity of computer-implemented services. For example, the computer-implemented services may include data storage services, instant messaging services, database services, and/or any other type of service that may be implemented with a computing device. Other types of computer-implemented services may be provided by the system without departing from embodiments disclosed herein.

The computer-implemented services may be provided using data processing systems 104 (and/or other devices) to any number of downstream consumers of the computer-implemented services (e.g., users of data processing systems 104 such as businesses and/or individuals). Data processing systems 104 may include any number of hardware components, such as processors, memory modules, storage devices, communication devices, etc. The hardware components of data processing systems 104 may support execution of any number and/or type of software components (e.g., applications and/or other types of software programs). Changes in available functionalities of the hardware components and/or the software components of data processing systems 104 may provide for various types of different computer-implemented services to be provided to the downstream consumers.

Over time, the software components of data processing systems 104 may be modified. For example, portions of the software components may be updated to improve performance of data processing systems 104, add functionality to data processing systems 104, reduce a security risk associated with a portion of the software components, etc. Updates and/or other modifications made to the software components of data processing systems 104 may allow for additional computer-implemented services to be provided, more reliable computer-implemented services to be provided, the computer-implemented services to be provided in a more secure manner, and/or other improvements to the computer-implemented services provided to the downstream consumers.

To modify the software components of data processing systems 104, the system may include any number of user devices 100. User devices 100 may be used by users such as programmers, developers, engineers, and/or other users to generate, update, modify, and/or otherwise manage at least a portion of the software components of data processing systems 104. User devices 100 may also be used by semi and/or fully automated entities to perform similar functions. For example, user devices 100 may be used to modify the software components by integrating changes to source code for a software program (e.g., a portion of the software components) into a codebase for the software program.

However, integrating the changes into the codebase may have undesired impacts on the software program. For example, the changes may introduce bugs and/or errors into the software program, reduce maintainability of the software program, introduce compatibility and/or performance issues, introduce security issues (e.g., introduce new security vulnerabilities and/or expose existing security vulnerabilities), and/or result in other undesired impacts on the software program. Consequently, the computer-implemented services provided to the downstream consumers using the software program may be delayed, provided in a manner that does not meet the expectations of the downstream consumers, and/or may otherwise be negatively impacted.

In general, embodiments disclosed herein may provide methods, systems, and/or devices for integrating changes to source code for a software program into a codebase in a manner that reduces a likelihood of negatively impacting computer-implemented services provided using the software program. To do so, a set of changes for the codebase including potential changes to the source code for the software program may be obtained from an entity (e.g., a person and/or automated entity that generated the set of changes). The set of changes may be analyzed to obtain change characteristics for the set of changes. Based on the change characteristics, a reviewing process for the set of changes may be performed to determine whether the set of changes is to be integrated into the codebase. If it is determined that the set of changes is to be integrated into the codebase, the set of changes may be integrated into the codebase to obtain an updated version of the software program to continue provision of the computer-implemented services.

The change characteristics may include: (i) a change magnitude for the set of changes, (ii) a subject for at least a portion of the set of changes, and/or (iii) upstream dependencies for functionalities of the software program that would be modified should the set of changes be integrated into the codebase. Obtaining the change magnitude may include performing a first analysis process for the set of changes, which may include obtaining a criticality value and a similarity value for the set of changes. The criticality value may indicate a degree of impact of integrating the set of changes into the codebase. For example, the criticality value may be evaluated based on a number of application programming interfaces (APIs) of an API call chain impacted by the set of changes. The similarity value may indicate a degree of similarity between the source code before and the source code after the integration of the set of changes into the codebase (e.g., based on changes in functionality of the software program and/or other similarity metrics).

Based on the change characteristics, a reviewing pipeline may be obtained and used to perform the review process for the set of changes. The reviewing pipeline may indicate: (i) entities (e.g., reviewers) that are to perform portions of the review process, (ii) an ordering between the portions of the review process, and/or (iii) outcomes of the portions of the review process indicating whether the set of changes is to be integrated into the codebase. By performing the review process based on the change characteristics, embodiments disclosed herein may reduce a likelihood of errors being introduced into the codebase and/or other undesired impacts on the functionality of the software program. As a result, a likelihood of providing the computer-implemented services in a manner that meets the expectations of downstream consumers of the computer-implemented services may be improved.

To provide the above noted functionality, the system of FIG. 1 may include user devices 100, management system 102, data processing systems 104, and communication system 106. Each of these components is discussed below.

Data processing systems 104 may include any number and/or type of data processing systems (e.g., 104A-104N). Each data processing system of data processing systems 104 may include hardware and/or software components (e.g., software programs) configured to facilitate the provision of all, or a portion of, the computer-implemented services to downstream consumers of the computer-implemented services (e.g., users of data processing systems 104). The downstream consumers may include, for example, businesses, individuals, and/or other users that may consume computer-implemented services provided using data processing systems 104.

For example, a data processing system (e.g., data processing system 104A) may be used by a hospital (e.g., a downstream consumer) to store patient information. The computer-implemented services provided using data processing system 104A may include secure data storage services, which may be facilitated using a security program (e.g., a software component of data processing system 104A). The security program may be used to encrypt the patient information, regulate access to the patient information, and/or otherwise protect the patient information from being accessed by unauthorized entities.

The software programs may be updated, modified, and/or otherwise maintained using user devices 100. User devices 100 may include any type and/or quantity of user devices (e.g., 100A-100N), which may include data processing systems and/or other computing devices. Users (e.g., persons, semi and/or fully automated entities) of user devices 100 may have various roles related to maintaining and/or modifying the functionality software programs of data processing systems 104. For example, the user roles may include writing initial source code for the software programs, identifying functionalities (e.g., desired by the downstream consumers) to be added to the software programs, identifying security vulnerabilities of the software programs, obtaining sets of changes for codebases associated with the software programs, performing portions of review processes for sets of changes, and/or performing other tasks.

The sets of changes may be obtained to: (i) address bugs and/or other errors in the source code (e.g., that cause the software programs to operate in unexpected and/or undesired manners), (ii) improve performance of the software programs (e.g., to allow the software programs to run faster, use less memory, and/or consume fewer resources), (iii) address security vulnerabilities, (iv) add the desired functionalities to the software programs, (iv) adapt to changes in underlying environments and/or technologies used by the software programs, and/or (v) otherwise improve and/or maintain the software programs.

Returning to the above example, the security program used to provide the secure data storage services may be updated to improve security of the patient information and/or add functionality to the security program, such as additional authentication procedures to reduce a likelihood of the patient information being accessed by unauthorized users. A set of changes may be generated using user device 100A to update the source code of the codebase for the security program.

User devices 100 may be managed by management system 102. Management system 102 may include any number and/or type of devices (e.g., data processing systems) used to manage codebases and/or tasks performed by user devices 100 related to the codebases. For example, management system 102 may: (i) obtain the sets of changes (e.g., from user devices 100), (ii) perform analysis processes for the sets of changes, (iii) establish reviewing processes for the sets of changes, (iv) manage integration of the sets of changes into the codebases (e.g., based on policies for managing codebases), (v) perform tasks related to maintaining the codebases, and/or (vi) perform other tasks to facilitate provision of the computer-implemented services using the software programs used by data processing systems 104.

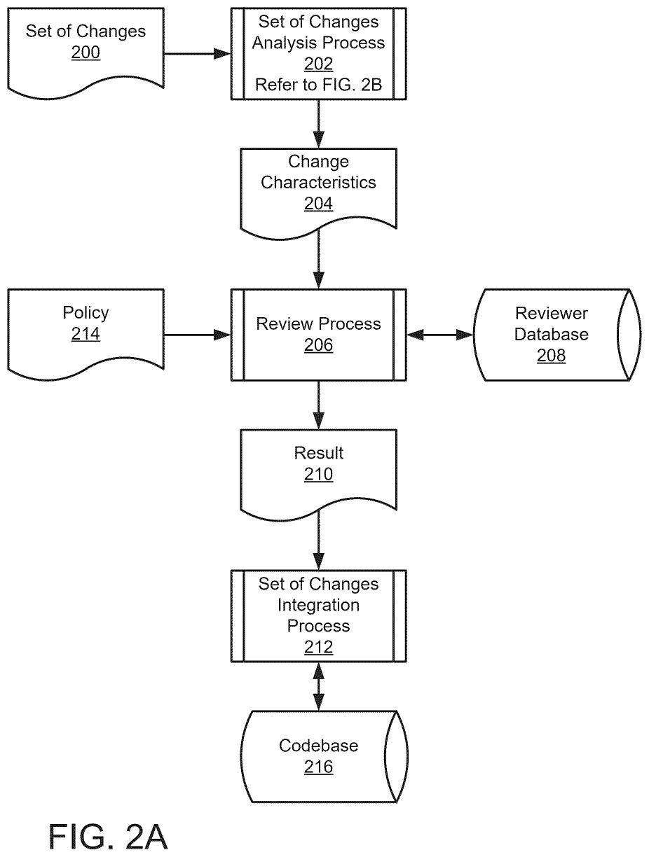

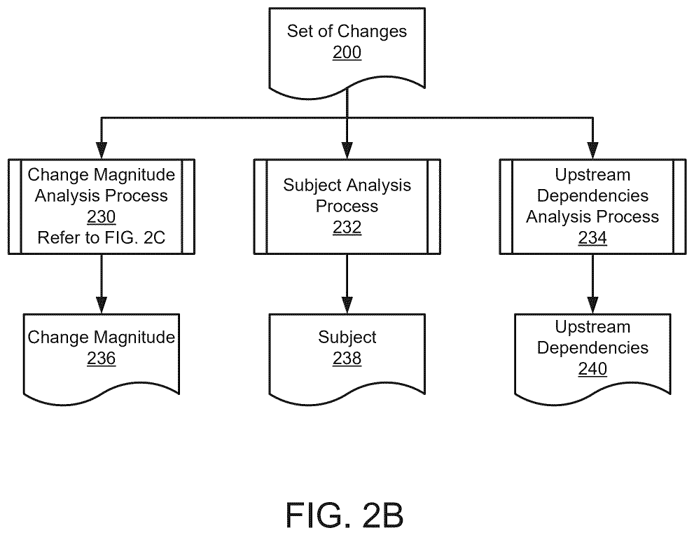

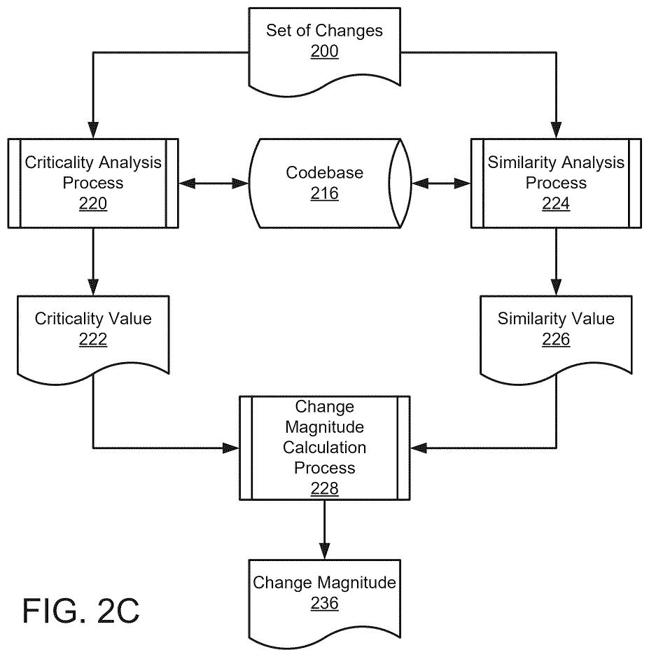

For example, management system 102 may perform analysis processes to obtain change characteristics for sets of changes, and may use the change characteristics to establish reviewing processes for the sets of changes. Establishing the reviewing processes may include obtaining reviewing pipelines for the sets of changes, which may indicate entities (e.g., reviewers) that are to perform portions of the reviewing processes. The entities may include users (e.g., persons), semi-automated entities, and/or fully automated entities which may use user devices 100 to perform the portions of the reviewing processes. By performing its functionality, management system 102 may reduce a likelihood of undesired impacts on the software programs as a result of integrating sets of changes into the codebases. Refer to the description of FIGS. 2A-2C for additional details regarding analysis of sets of changes and integration of sets of changes into codebases.

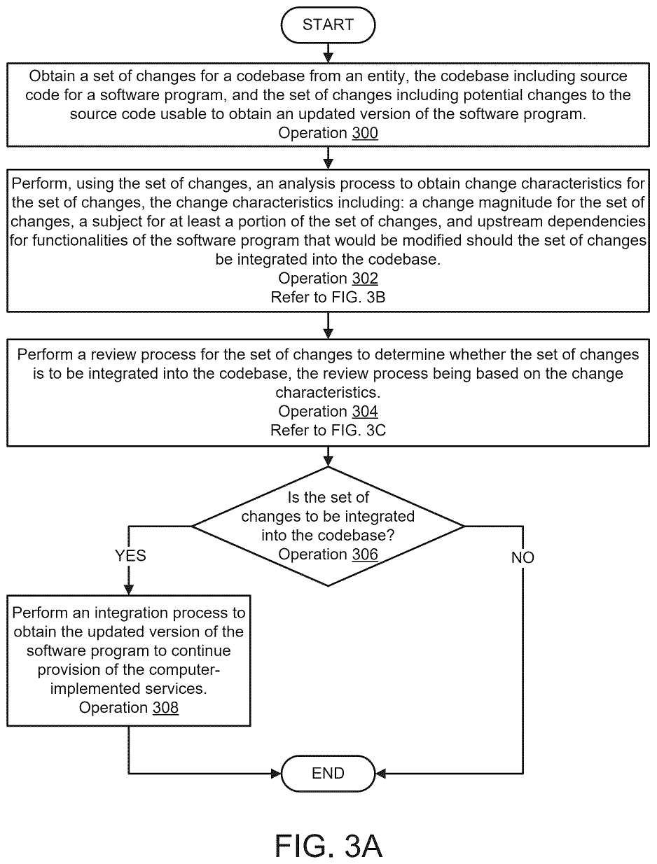

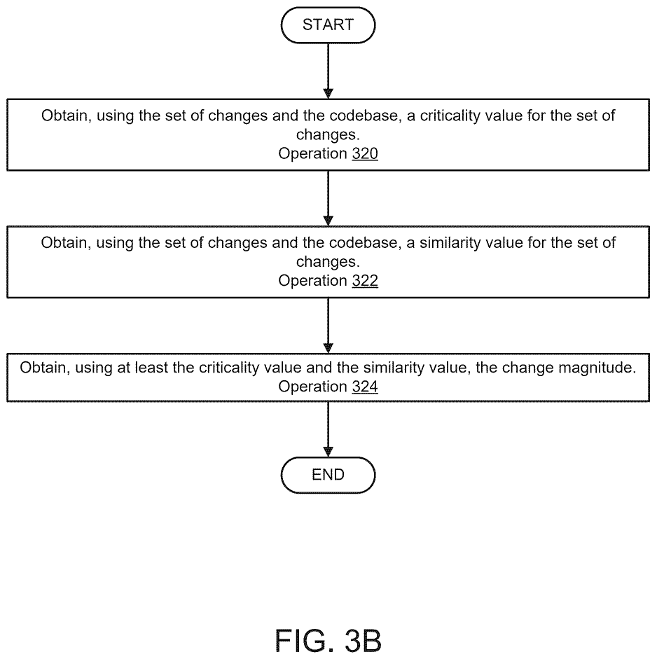

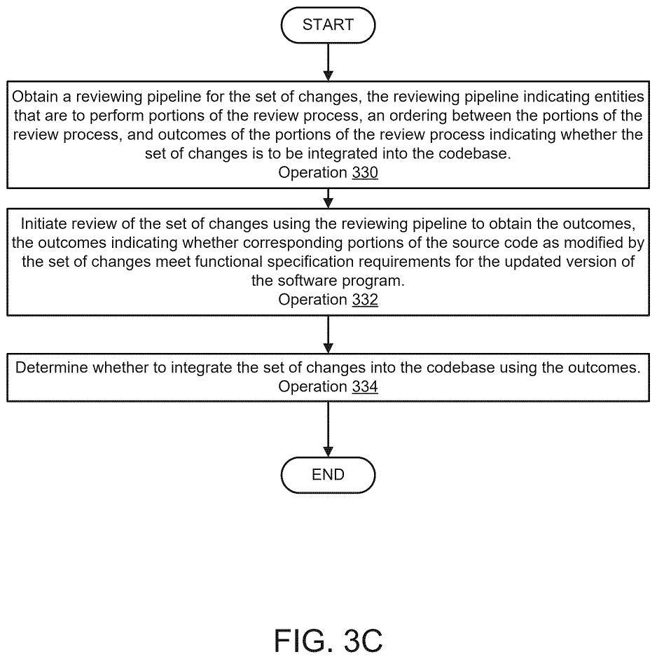

When providing their functionality, any of (and/or components thereof) user devices 100, management system 102, and/or data processing systems 104 may perform all, or a portion, of the actions and methods illustrated in FIGS. 2A-3C.

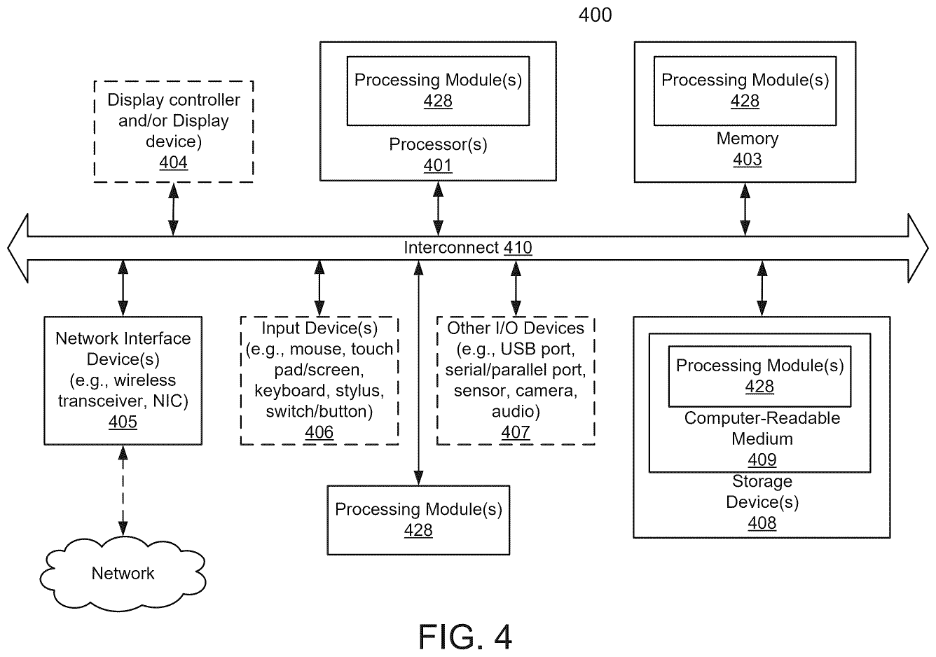

Any of (and/or components thereof) user devices 100, management system 102, and/or data processing systems 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Management system 102 may be implemented with multiple computing devices. The computing devices of management system 102 may cooperatively perform processes for managing codebases. The computing devices of management system 102 may perform similar and/or different functions, and may be used by different entities that may participate in the management of codebases. For example, management system 102 may include multiple computing devices used by managers, programmers, developers, engineers, and/or other entities tasked with managing codebases.

Management system 102 may be maintained, for example, by a business or other entity that has some degree of responsibility with respect to managing the operation of user devices 100. For example, management system 102 may be operated by a software company that employs and/or otherwise cooperates with users of user devices 100.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

The system described in FIG. 1 may be used to facilitate provision of computer-implemented services using a data processing system. The following processes described in FIGS. 2A-2C may be performed by the system in FIG. 1 when providing this functionality.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 204, etc.) is used to represent data structures, a second set of shapes (e.g., 202, 206, etc.) is used to represent processes performed using and/or that generate data, and a third set of shapes (e.g., 208, 216, etc.) is used to represent large scale data structures such as databases.

Turning to FIG. 2A, a first data flow diagram in accordance with an embodiment is shown. The first data flow diagram may illustrate data used in and data processing performed in managing integration of a set of changes (e.g., set of changes 200) into a codebase for a software program (e.g., codebase 216).

To do so, set of changes 200 for codebase 216 may be obtained from an entity (e.g., a user of user devices 100 shown in FIG. 1). The entity may include a person and/or semi or fully automated entities (e.g., generative artificial intelligence (AI) models). Codebase 216 may include source code for a software program, which may include a set of instructions and/or other code (e.g., written by programmers, software developers, semi and/or fully automated entities, and/or other entities) for performing actions related to running the software program. Codebase 216 may include source code written in any programming language (e.g., Python, HTML, C++, Java).

Set of changes 200 may include potential changes to at least a portion of the source code included in codebase 216, which may be usable to obtain an updated version of the software program. For example, set of changes 200 may include a set of alterations for the at least the portion of the source code packaged together, and/or metadata regarding the set of alterations (e.g., a description of set of changes 200 provided by a user who wrote set of changes 200, an identifier for the user, a date set of changes 200 was written). Refer to the description of FIG. 1 for additional details regarding sets of changes for codebases.

Set of changes 200 may be used to perform set of changes analysis process 202 to obtain change characteristics 204 for set of changes 200. Change characteristics 204 may include: (i) a change magnitude for set of changes 200, (ii) a subject for at least a portion of set of changes 200, (iii) upstream dependencies for functionalities of the software program that would be modified should set of changes 200 be integrated into codebase 216, and/or (iv) other characteristics of set of changes 200 (e.g., information regarding the entity that provided set of changes 200). Refer to the description of FIGS. 2B-2C for additional details regarding obtaining change characteristics 204.

The change magnitude may indicate a level of change to the source code should set of changes 200 be integrated into codebase 216. For example, the level of change may include a difference in functionality of the software program before and after integration of set of changes 200 (e.g., rather than a change in size of the source code). For example, obtaining a higher change magnitude (e.g., based on a numerical and/or any other type of scale) may indicate integrating set of changes 200 into codebase 216 has an increased risk of undesired and/or unintended impacts on the updated version of the software program.

For example, a data processing system (e.g., of data processing systems 104 described in FIG. 1) may include an antivirus software program. The antivirus software program may include functionalities for detecting malware on the data processing system. A first set of changes may be obtained for the antivirus software program including minor revisions to the source code intended to enhance readability of a portion of the source code. A change magnitude of 2 (e.g., on a scale of 1-10, where a change magnitude of 10 represents the highest level of change to the source code) may be obtained for the first set of changes. A second set of changes may be obtained for the antivirus software program intended to add functionality of the antivirus software program to remove detected malware from the data processing system. The second set of changes may include revising a larger portion of the source code relative to the first set of changes. As a result, a change magnitude of 8 may be obtained for the second set of changes. Thus, integrating the second set of changes into the codebase may have a higher risk of undesired impacts on the antivirus software program than integrating the first set of changes into the codebase.

The subject for the at least the portion of set of changes 200 may include a field, topic, and/or other technical area for the at least the portion of set of changes 200. Set of changes 200 may include one or multiple subjects, and a subject may be obtained for each portion of set of changes 200. For example, set of changes 200 may include a first portion intended to modify source code responsible for rendering graphical user interface (GUI) elements for the software program, and a second portion intended to update a data storage process for the software program. The subject for the first portion of set of changes 200 may be a GUI subject, and the subject for the second portion of set of changes 200 may be a storage subject.

Upstream dependencies may include any number and/or type of software components which invoke functionality of the portion of the software program that may be modified by integrating set of changes 200 into codebase 216. For example, set of changes 200 may be intended change functionality of the software program by adding, removing, and/or modifying features of the software program. The changes may impact upstream software components that rely on the features of the software program that are to be changed. For example, if set of changes 200 removes a feature used by an upstream software component, performance of the upstream software component may be impacted. In another example, if set of changes 200 modifies a feature used by the upstream software component, compatibility issues between the software program and the upstream software component may be introduced.

Change characteristics 204 may be used to perform review process 206. During review process 206, set of changes 200 may be reviewed to determine whether set of changes 200 is to be integrated into codebase 216. Review process 206 may be based on change characteristics 204. For example, during review process 206, a reviewing pipeline may be obtained for set of changes 200 using change characteristics 204 (e.g., by a management entity such as management system 102 shown in FIG. 1). The reviewing pipeline may indicate: (i) entities (e.g., persons, semi and/or fully automated entities) that are to perform portions of review process 206 (also referred to as reviewers), and/or (ii) an ordering between the portions of review process 206 (e.g., indicating an order in which each portion of review process 206 is to be performed). The reviewers indicated by the reviewing pipeline may include users of user devices 100 (shown in FIG. 1) and, in some combination, evaluate whether set of changes 200 is to be integrated into codebase 216.

For example, the reviewing pipeline may indicate that a first user, a second user, and a first AI model (e.g., three reviewers) are to perform a first portion, a second portion, and a third portion of review process 206. The reviewing pipeline may also indicate that the first AI model is to perform the first portion, the first user is to perform the second portion, and the second user is to perform the third portion of review process 206 (e.g., sequentially).

To obtain the reviewing pipeline, a portion of reviewers that are qualified to review set of changes 200 may be identified from reviewer database 208. Reviewer database 208 may include a database, repository, list, and/or any other type of data structure including information regarding the reviewers. Reviewer database 208 may include: (i) identifiers for the reviewers (e.g., names and/or identification numbers), (ii) subjects (e.g., technical areas, fields, and/or topics) for sets of changes for which the reviewers are qualified to review, (iii) reviewer characteristics for each of the reviewers, and/or (iv) other information. The reviewer characteristics may include: (i) reviewer job ranking (e.g., entry-level, senior, principal), (ii) reviewer experience level (e.g., years of experience, other metrics for designating levels of experience), (iii) reviewer area of expertise (e.g., a subject(s) for which each reviewer most qualified to review), and/or (iv) other characteristics.

The portion of reviewers that are qualified to review at least a portion of set of changes 200 may be identified from reviewer database 208 based on a knowledge base of the reviewers. To do so, the portion of reviewers may be identified based on: (i) the subject for the at least the portion of set of changes 200, and/or (ii) the upstream dependencies for functionalities of the software program that would be modified should the at least the portion of set of changes 200 be integrated into codebase 216. For example, set of changes 200 may be intended to address a security vulnerability of a software program. It may be determined that a first portion of set of changes 200 has a security subject, and one upstream dependency may be identified. The portion of reviewers that are qualified to review the first portion of set of changes 200 may include: (i) reviewers that are qualified to review sets of changes with a security subject, and/or (ii) reviewers that are qualified to review sets of changes impacting the upstream dependency. In doing so, the portion of reviewers may be identified that has a knowledge base to review the first portion of set of changes 200.

From the portion of reviewers, at least one reviewer may be selected for inclusion in the reviewing pipeline based on at least the reviewer characteristics for the reviewers and the change magnitude for set of changes 200. To select the at least one reviewer, reviewer requirements for set of changes 200 (not shown) may be identified as part of performing review process 206. The reviewer requirements may include any number and/or type of requirements for reviewers of at least a portion of set of changes 200 to reduce a risk of undesired impacts on the updated version of the software program should set of changes 200 be integrated into codebase 216.

For example, the reviewer requirements may include: (i) a number of reviewers required to review the at least the portion of set of changes 200 prior to integration of set of changes 200 into codebase 216, (ii) a job ranking for the reviewers, (iii) an experience level for the reviewers, (iv) a knowledge base of the reviewers (e.g., knowledge of a subject of the at least the portion of set of changes 200 and/or an upstream dependency), and/or (v) other requirements.

The reviewer requirements may be based on: (i) change characteristics 204, (ii) entity characteristics for the entity (e.g., that generated set of changes 200) (not shown), and/or (iii) a reviewer rule set (e.g., policy 214). Entity characteristics for the entity may include: (i) a type of entity (e.g., a person, a generative AI model), (ii) a job ranking for the entity (e.g., entry-level, senior, principal), (iii) an experience level for the entity (e.g., years of experience, other metrics for designating levels of experience), and/or (iv) other characteristics for the entity. For example, a first set of changes obtained from a first user (e.g., entity) with a high job ranking and/or level of experience may be less likely to contain errors than a second set of changes obtained from a second user with a low job ranking and/or level of experience. As a result, the reviewer requirements for the first set of changes may be lower than the reviewer requirements for the second set of changes. In another example, a third set of changes may be generated by an AI model and, based on a type of entity, reviewer requirements for the third set of changes may be obtained.

To obtain the reviewer requirements, policy 214 may be used. Policy 214 may include a policy, schema, and/or other type of reviewer rule set usable to determine reviewer requirements for at least portions of sets of changes. Policy 214 may be obtained from an SME, management entity of the software program, and/or any other entity that participates in managing integration of set of changes 200 into codebase 216 (e.g., management system 102 shown in FIG. 1). Reviewer requirements obtained based on policy 214 may specify reviewers to review all and/or a portion of set of changes 200. For example, the reviewer requirements may indicate a first portion of set of changes 200 is to be reviewed by reviewers having specified reviewer characteristics, such as expertise of a subject of the first portion of set of changes 200.

Policy 214 may be keyed to the change magnitude (e.g., included in change characteristics 204), and may dedicate increasing resources for review of set of changes 200 as the change magnitude increases and decreasing resources for the review of set of changes 200 as the change magnitude decreases. In doing so, the change magnitude may be used as a proxy for risk of undesired impacts on the updated version of the software program should set of changes 200 be integrated into codebase 216, and mitigating an increased risk of the undesired impacts may result in a larger resource consumption to meet the reviewer requirements.

Policy 214 may include a scoring system used to obtain reviewer requirements based on scores assigned to sets of changes. The scoring system may relate the scores to levels of risk of the undesired impacts, and the reviewer requirements may be obtained based on policy 214 to mitigate the levels of risk.

For example, policy 214 may include a scoring system based on numerical scores assigned to sets of changes on a scale of 1-10, where a score of 1 indicates a lowest level of risk of the undesired impacts, and a score of 10 indicates a highest level of risk of the undesired impacts. A set of changes may be obtained from a user, and based on a change magnitude for the set of changes, a first score of 7 may be assigned to the set of changes. The first score may then be modified based on entity characteristics for the user. For example, if the user has a senior-level job ranking, the first score may be reduced, and a second score of 5 may be obtained for the set of changes. Policy 214 may indicate reviewer requirements for sets of changes assigned a score of 5 may include 3 reviewers, where at least one reviewer is a senior-level reviewer. Based on policy 214, reviewer requirements for the set of changes may be obtained including 3 reviewers, where at least one reviewer is a senior-level reviewer.

The at least one reviewer may be selected from the portion of reviewers, based on the reviewer characteristics, that meets the reviewer requirements for set of changes 200. The at least one reviewer may include a team of reviewers that, in aggregate, meets the reviewer requirements for set of changes 200. The team of reviewers may include at least one SME (e.g., person), and/or may include at least one fully automated entity (e.g., an AI model). For example, the team of reviewers may include 2 large language models (e.g., LLMs, a type of AI model), each of which performs dedicated tasks such as error analysis (e.g., checking code for syntax and/or other errors), functionality analysis (e.g., checking code to determine whether desired functionality is included), etc. Following review by the 2 LLMs, the SME (e.g., a third reviewer) may perform a review of set of changes 200.

Performing review process 206 may include initiating review of set of changes 200 using the reviewing pipeline to obtain outcomes from the reviewers, the outcomes indicating whether corresponding portions of the source code as modified by set of changes 200 meet functional specification requirements for the updated version of the software program. The functional specification requirements may include an ability of the updated version of the software program to perform its functionality (e.g., as desired by a consumer of computer-implemented services provided using the updated version of the software program) without introducing undesired impacts on the updated version of the software program (and/or upstream dependencies of functionalities of the updated version of the software program).

Outcomes of the portions of review process 206 may be obtained from the reviewers of the portions, and may be used to determine whether to integrate set of changes 200 into codebase 216. For example, the outcomes may include: (i) an indication of whether each reviewer determines that set of changes 200 meets the functional specification requirements (e.g., a “yes” or “no” determination), (ii) any comments from the reviewers obtained during performance of the portions of review process 206 (e.g., feedback and/or edits for set of changes 200), and/or (iii) other information.

Using the outcomes, result 210 may be obtained. Result 210 may include: (i) a list of the outcomes of the review process, where each of the outcomes includes an indication from the associated reviewer regarding whether set of changes 200 meets the functional specification requirements, (ii) an aggregated result obtained by analyzing the outcomes (e.g., using any analysis method), the aggregated result indicating whether set of changes 200 meets the functional specification requirements (e.g., a “yes” or “no” determination), (iii) other information included in the outcomes, and/or (iv) other information.

If result 210 indicates set of changes 200 meets the functional specification requirements, set of changes integration process 212 may be performed. During set of changes integration process 212, an integration process may be performed to obtain the updated version of the software program to continue provision of the computer-implemented services.

If result 210 indicates set of changes 200 does not meet the functional specification requirements, at least one action may be identified (e.g., based on policy 214 and/or any other policy obtained from a management entity) to manage integration of set of changes 200 into codebase 216. For example, the at least one action may include: (i) rejecting at least a portion of set of changes 200, (ii) assigning a user (e.g., of user devices 100 shown in FIG. 1) to edit set of changes 200 (e.g., based on feedback and/or edits received from the reviewers as part of the outcomes) prior to integrating set of changes 200 into codebase 216, and/or (iii) other actions.

Turning to FIG. 2B, a second data flow diagram in accordance with an embodiment is shown. The second data flow diagram may illustrate data used in and data processing performed, at least in part, in performing an analysis process to obtain change characteristics (e.g., change characteristics 204) for a set of changes (e.g., set of changes 200). FIG. 2B may be an expansion of set of changes analysis process 202 shown in FIG. 2A.

The analysis process may be performed to obtain change characteristics 204 for set of changes 200, and change characteristics 204 may include: (i) change magnitude 236, (ii) subject 238, and/or (iii) upstream dependencies 240. For additional details regarding change characteristics 204, refer to FIG. 2A.

Performing the analysis process may include performing change magnitude analysis process 230. During change magnitude analysis process 230, a first analysis process may be performed to obtain change magnitude 236 for set of changes 200. Change magnitude 236 may indicate a level of change to source code for a software program should set of changes 200 be integrated into a codebase (e.g., codebase 216, refer to FIG. 2A). For additional details regarding performing change magnitude analysis process 230, refer to FIG. 2C.

Performing the analysis process may also include performing subject analysis process 232. During subject analysis process 232, a second analysis process may be performed to obtain subject 238 for at least a portion of set of changes 200. Performing the second analysis process may include: (i) identifying subject 238 based on annotations for set of changes 200 (e.g., by analyzing the annotations using any analysis method), (ii) identifying subject 238 by an AI model and/or SME based on the source code and/or set of changes 200, (iii) identifying, by an SME and/or AI model, subject 238 by analyzing a textual summary (e.g., generated by an LLM) of the source code and/or set of changes 200, and/or (iv) other methods. For additional details regarding textual summaries of code, refer to FIG. 2C.

The annotations may indicate subject 238 for portions of set of changes 200 and/or the source code being modified by the portions of set of changes 200. The annotations may also indicate functionality, purpose, and/or other information regarding the portions usable to obtain subject 238. The annotations may be obtained via: (i) adding the annotations to the portions of the source code and/or set of changes 200 by the entity generating the source code and/or set of changes 200, (ii) adding the annotations by an LLM and/or other natural language processing model based on an analysis of the source code and/or set of changes 200, (iii) adding the annotations by an SME based on an analysis of the source code and/or set of changes 200, and/or (iv) other methods.

Performing the analysis process may also include performing upstream dependencies analysis process 234. During upstream dependencies analysis process 234, a third analysis process may be performed to obtain upstream dependencies 240 (e.g., upstream dependencies for the functionalities of the software program that would be modified should set of changes 200 be integrated into the codebase). Performing the third analysis process to obtain upstream dependencies 240 may include: (i) using dependency management tools to analyze portions of the source code that would be modified by set of changes 200, (ii) using a correlation header to trace the flow of a request through a distributed system to identify dependencies, (iii) using a dependency visualization tool to analyze dependencies (e.g., via generation of a dependency graph), and/or (iv) other methods.

Thus, by implementing the processes illustrated in FIG. 2B, a system in accordance with embodiments disclosed herein may be used to obtain change characteristics for a set of changes (e.g., a change magnitude, a subject for at least a portion of the set of changes, upstream dependencies). The change characteristics may be used to perform at least a portion of the processes described in FIG. 2A.

Turning to FIG. 2C, a third data flow diagram in accordance with an embodiment is shown. The third data flow diagram may illustrate data used in and data processing performed, at least in part, in performing a first analysis process to obtain a change magnitude (e.g., change magnitude 236) for a set of changes (e.g., set of changes 200). FIG. 2C may be an expansion of change magnitude analysis process 230 shown in FIG. 2B.

Performing the analysis process to obtain change magnitude 236 may include (i) obtaining, using set of changes 200 and codebase 216, criticality value 222 for set of changes 200, (ii) obtaining, using set of changes 200 and codebase 216, similarity value 226 for set of changes 200, (iii) obtaining, using at least criticality value 222 and/or similarity value 226, change magnitude 236, and/or (iv) performing other tasks to obtain change magnitude 236.

To obtain criticality value 222, criticality analysis process 220 may be performed. During criticality analysis process 220, a degree of impact of integrating set of changes 200 into codebase 216 may be evaluated. The degree of impact may be based on a number of application programming interfaces (APIs) impacted by set of changes 200.

To evaluate the degree of impact of integrating set of changes 200 into codebase 216, codebase 216 may be used to determine the number of APIs (e.g., of an API call chain) that would be impacted by integrating set of changes 200 into codebase 216. Determining the number of APIs that would be impacted may include: (i) identifying API calls within codebase 216 that would be impacted by set of changes 200, (ii) analyzing software dependencies to identify any external APIs that would be impacted by set of changes 200, (iii) analyzing API documentation used by the software program to identify APIs likely to be impacted by set of changes 200, and/or (iv) other methods. For example, the software program that is to be modified using set of changes 200 may impact an external API, which may impact an API call chain (e.g., originating from the external API). The degree of impact may be obtained based on a number of APIs in the API call chain associated with the external API impacted by set of changes 200. The degree of impact may include a value assigned based on any scale and/or rubric usable to indicate degrees of impact (e.g., a numerical scale, a letter scale, other types of scales).

Based on the degree of impact, criticality value 222 may be assigned to set of changes 200. For example, criticality value 222 may be assigned based on a schema, rule set, table, and/or other type data structure usable to assign criticality values to sets of changes based on degrees of impact. For example, criticality value 222 may include a value from 1-10, where a higher value indicates a larger number of APIs would be impacted by set of changes 200, and a lower value indicates fewer APIs would be impacted by set of changes 200.

To obtain similarity value 226, similarity analysis process 224 may be performed. During similarity analysis process 224, set of changes 200 and a trained machine learning model (e.g., a large language model (LLM) and/or other type of artificial intelligence model) may be used to obtain: (i) a first summary of set of changes 200, and (ii) a second summary of at least a portion of the source code that would be impacted by integrating set of changes 200 into codebase 216.

The first summary may include a description of the functionality, purpose, and/or other information regarding set of changes 200. The first summary may represent the at least the portion of the source code after integration of set of changes 200 into codebase 216. For example, the first summary may include human readable text generated by an LLM using set of changes 200 as ingest for the LLM.

The second summary may include a description of the functionality, purpose, and/or other information regarding the at least the portion of the source code. The second summary may represent the at least the portion of the source code prior to the integration of set of changes 200 into codebase 216. Obtaining the second summary may include methods similar to obtaining the first summary. For example, an LLM may be used to obtain the second summary, which may include human readable text generated using the at least the portion of the source code that would be impacted by set of changes 200 from codebase 216 as ingest for the LLM.

The first summary and the second summary may be compared to obtain a difference. Comparing the first summary and the second summary may include: (i) obtaining a first embedding (e.g., a numeric vector) for the first summary and a second embedding for the second summary (e.g., using an algorithm and/or other type of software program for converting a textual summary into a representative numeric vector), (ii) comparing the first embedding and the second embedding based on any method of comparing similarity of two embeddings (e.g., cosine similarity) to obtain a difference, and/or (iii) assigning similarity value 226 to set of changes 200 based on the difference. Similarity value 226 may include a value assigned based on any scale and/or rubric usable to indicate a degree of similarity between the source code before and after integration of set of changes 200 into codebase 216. By comparing the first embedding and the second embedding, changes to the functionality and/or meaning of the source code, rather than changes to size/length of the source code, may be evaluated.

While described with respect to obtaining similarity value 226 using embeddings of textual summaries, it will be appreciated that any other method for assessing similarity may be used without departing from embodiments disclosed herein. For example, similarity value 226 may be obtained by feeding the first summary and the second summary into an LLM, prompting the LLM to compare the first summary and the second summary, and obtaining the difference and/or similarity value 226 as output from the LLM.

Criticality value 222 and similarity value 226 may be used to perform change magnitude calculation process 228. During change magnitude calculation process 228, change magnitude 236 may be calculated based on criticality value 222 and similarity value 226. For example, change magnitude 236 may be calculated by obtaining a combined and/or calculated value. The combined and/or calculated value may include, for example, a weighted sum of criticality value 222 and similarity value 226. Weights applied to criticality value 222 and similarity value 226 may be determined by an SME, a management entity, and/or any other entity that participates in managing integration of sets of changes into codebases (e.g., management system 102 shown in FIG. 1).

It will be appreciated that change magnitude 236 may be obtained, evaluated, and/or calculated using any other method, algorithm, and/or calculation without departing from embodiments disclosed herein.

Thus, by implementing the processes illustrated in FIGS. 2A-2C, a system in accordance with embodiments disclosed herein may be used to manage integration of sets of changes to source code into codebases based on change characteristics for the sets of changes. The change characteristics may include a change magnitude, subject, and/or upstream dependencies, and may be used to establish a review process for the set of changes. Consequently, a likelihood of introducing undesired impacts to the codebase may be reduced, and computer-implemented services may be provided as desired to downstream consumers.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to provide computer-implemented services using a data processing system. FIGS. 3A-3C illustrate methods that may be performed by the components of the system of FIG. 1. In the diagrams discussed below and shown in FIGS. 3A-3C, any of the operations may be repeated, performed in different orders, and/or performed in parallel with or in a partially overlapping in time manner with other operations.

Turning to FIG. 3A, a first flow diagram illustrating a method for providing computer-implemented services using a data processing system in accordance with an embodiment is shown. The method may be performed, for example, by any of the components of the system of FIG. 1, and/or any other entity without departing from embodiments disclosed herein.

At operation 300, a set of changes for a codebase may be obtained from an entity, the codebase including source code for a software program, and the set of changes including potential changes to the source code usable to obtain an updated version of the software program. Obtaining the set of changes may include: (i) reading the set of changes from storage, (ii) receiving the set of changes from another entity, (iii) generating the set of changes (e.g., by the entity), and/or (iv) other methods.

Generating the set of changes may include: (i) identifying a modification that is to be made to at least a portion of the source code (e.g., to add functionalities to the software program, to improve security features, to fix errors in the source code), (ii) writing code that is to replace and/or be added to the source code to make the identified modification, (iii) packaging the code and/or metadata (e.g., including a description of the code, an identifier for the entity that wrote the code, a date the code was written) to obtain the set of changes, and/or (iv) other methods.

At operation 302, an analysis process may be performed using the set of changes to obtain change characteristics for the set of changes, the change characteristics including a change magnitude for the set of changes, a subject for at least a portion of the set of changes, and upstream dependencies for functionalities of the software program that would be modified should the set of changes be integrated into the codebase. Performing the analysis process may include: (i) performing a first analysis process to obtain the change magnitude for the set of changes, the change magnitude indicating a level of change to the source code should the set of changes be integrated into the codebase, (ii) performing a second analysis process to obtain the subject for the at least a portion of the set of changes, (iii) performing a third analysis process to obtain the upstream dependencies for the functionalities of the software program that would be modified should the set of changes be integrated into the codebase, (iv) providing the set of changes to another entity and receiving the change characteristics in response, and/or (v) other methods.

Performing the first analysis process may include: (i) obtaining, using the set of changes and the codebase, a criticality value for the set of changes, (ii) obtaining, using the set of changes and the codebase, a similarity value for the set of changes, (iii) obtaining, using at least the criticality value and the similarity value, the change magnitude, (iv) providing the set of changes to another entity and receiving the change magnitude in response, and/or (v) other methods. Refer to the description of FIG. 3B for additional details regarding performing the first analysis process.

Performing the second analysis process to obtain the subject for the at least a portion of the set of changes may include: (i) identifying the subject (e.g., by an SME and/or AI model) based on annotations for the set of changes and/or the source code, (ii) identifying the subject by an AI model based on an analysis of the set of changes and/or the source code, (iii) identifying the subject by an AI model based on a textual summary of the set of changes and/or the source code generated by an LLM and/or other type of AI model, (iv) identifying the subject by an SME based on an analysis of the set of changes, the source code, and/or the summary of the set of changes and/or the source code, (v) providing the set of changes to another entity and receiving the subject in response, and/or (vi) other methods.

Performing the third analysis process to obtain the upstream dependencies may include: (i) using dependency management tools to analyze portions of the source code that would be modified by set of changes 200, (ii) using a correlation header to trace the flow of a request through a distributed system to identify dependencies, (iii) using a dependency visualization tool to analyze dependencies (e.g., via generation of a dependency graph), and/or (iv) other methods.

At operation 304, a review process may be performed for the set of changes to determine whether the set of changes is to be integrated into the codebase, the review process being based on the change characteristics. Performing the review process may include: (i) obtaining a reviewing pipeline for the set of changes, the reviewing pipeline indicating entities that are to perform portions of the review process, an ordering between the portions of the review process, and outcomes of the portions of the review process indicating whether the set of changes is to be integrated into the codebase, (ii) initiating review of the set of changes using the reviewing pipeline to obtain the outcomes, the outcomes indicating whether corresponding portions of the source code as modified by the set of changes meet functional specification requirements for the updated version of the software program, (iii) determining whether to integrate the set of changes into the codebase using the outcomes, (iv) providing the change characteristics and/or the set of changes to another entity responsible for performing the review process, and/or (v) other methods. Refer to the description of FIG. 3C for additional details regarding performing the review process.

At operation 306, it may be determined whether the set of changes is to be integrated into the codebase. Making the determination may include: (i) obtaining the outcomes of the review process, (ii) analyzing the outcomes to determine whether the outcomes indicate that the set of changes is to be integrated into the codebase (e.g., parsing the outcomes, aggregating the outcomes to obtain a result, the result indicating whether the set of changes is to be integrated into the codebase), (iii) reading the determination from storage, (iv) receiving the determination from another entity, and/or (v) other methods.

If the set of changes is to be integrated into the codebase (e.g., the determination is “Yes” at operation 306), then the method may proceed to operation 308.

At operation 308, an integration process may be performed to obtain the updated version of the software program to continue provision of the computer-implemented services. Performing the integration process may include: (i) replacing at least a portion of the source code with code included in the set of changes, (ii) modifying at least a portion of the source code based on the set of changes, (iii) adding code included in the set of changes to the source code, (iv) providing the set of changes to another entity (e.g., a management entity of the codebase) responsible for integrating the set of changes into the codebase, (v) notifying another entity that the set of changes is to be integrated into the codebase, and/or (vi) other methods.

The method may end following operation 308.

Returning to operation 306, if the set of changes is not to be integrated into the codebase (e.g., the determination is “No” at operation 306), then the method may end. Based on the determination, at least one action may be performed to manage integration of the set of changes into the codebase. Performing the at least one action may include: (i) rejecting at least a portion of the set of changes, (ii) assigning an SME to edit the set of changes prior to integrating the set of changes into the codebase, and/or (iii) other methods.

Turning to FIG. 3B, a second flow diagram illustrating a method for providing computer-implemented services using a data processing system in accordance with an embodiment is shown. The method may be performed, for example, by any of the components of the system of FIG. 1, and/or any other entity without departing from embodiments disclosed herein. The operations described in FIG. 3B may be an expansion of operation 302 shown in FIG. 3A.

At operation 320, a criticality value for the set of changes may be obtained using the set of changes and the codebase. Obtaining the criticality value may include: (i) evaluating a degree of impact of integrating the set of changes into the codebase, the degree of impact being based on a number of APIs impacted by the set of changes, (ii) assigning, based on the degree of impact, the criticality value, (iii) receiving the criticality value from another entity, (iv) reading the criticality value from storage, and/or (v) other methods.

Evaluating the degree of impact of integrating the set of changes into the codebase may include: (i) obtaining the number of APIs impacted by the set of changes, (ii) obtaining, based on the number of APIs, the degree of impact, (iii) receiving the degree of impact from another entity, and/or (iv) other methods.

Obtaining the number of APIs impacted by the set of changes may include: (i) identifying API calls within the codebase that would be impacted by the set of changes, (ii) analyzing software dependencies to identify any external APIs that would be impacted by the set of changes, (iii) analyzing API documentation used by the software program to identify APIs likely to be impacted by the set of changes, (iv) reading the number of APIs from storage, (v) receiving the number of APIs from another entity, and/or (vi) other methods.

Obtaining the degree of impact based on the number of APIs may include: (i) assigning the degree of impact based on the number of APIs (e.g., if the number of APIs is 20, the degree of impact may be 20), (ii) identifying the degree of impact using a schema, rule set, table, and/or other data structure usable to obtain degrees of impact based on the number of APIs, (iii) providing the number of APIs to another entity and receiving the degree of impact in response, and/or (iv) other methods.

Assigning the criticality value based on the degree of impact may include: (i) searching a schema, rule set, table, and/or other data structure using the degree of impact as a key for the search to identify the criticality value, (ii) providing the degree of impact to another entity and receiving the criticality value in response, and/or (iii) other methods.

At operation 322, a similarity value for the set of changes may be obtained using the set of changes and the codebase. Obtaining the similarity value may include: (i) obtaining, using the set of changes and a trained machine learning model, a first summary of the set of changes and a second summary of at least a portion of the source code that would be impacted by integrating the set of changes into the codebase, (ii) comparing the first summary and the second summary to obtain a difference, (iii) assigning, based on the difference, the similarity value, (iv) receiving the similarity value from another entity, (v) reading the similarity value from storage, and/or (vi) other methods.

Obtaining the first summary of the set of changes and the second summary of the at least the portion of the source code may include: (i) feeding the set of changes and the at least the portion of the source code into the trained machine learning model (e.g., an LLM) as ingest, (ii) prompting the trained machine learning model to summarize the set of changes and the at least the portion of the source code, (iii) obtaining the first summary and the second summary as output from the trained machine learning model, (iv) providing the set of changes and/or the at least the portion of the source code to another entity (e.g., that hosts and/or operates the trained machine learning model) and receiving the first summary and/or the second summary in response, and/or (v) other methods.

Comparing the first summary and the second summary to obtain the difference may include: (i) obtaining a first embedding (e.g., a numeric vector) for the first summary and a second embedding for the second summary (e.g., using an algorithm and/or other type of software program for converting a textual summary into a representative numeric vector), (ii) comparing the first embedding and the second embedding based on any method of comparing similarity of two embeddings (e.g., cosine similarity) to obtain the difference, (iii) feeding the first summary and the second summary to an LLM as ingest, (iv) prompting the LLM to compare the first summary and the second summary, (v) obtaining the difference as output from the LLM, (vi) providing the first summary and the second summary to another entity responsible for comparing the first summary and the second summary and receiving the difference in response, and/or (vii) other methods.

Assigning the similarity value based on the difference may include: (i) searching a schema, rule set, table, and/or other data structure using the difference as a key for the search to identify the similarity value, (ii) providing the difference to another entity and receiving the similarity value in response, and/or (iii) other methods.

At operation 324, the change magnitude may be obtained using at least the criticality value and the similarity value. Obtaining the change magnitude may include: (i) calculating the change magnitude using the criticality value and the similarity value, (ii) providing the criticality value and the similarity value to another entity and receiving the change magnitude in response, and/or (iii) other methods.

Calculating the change magnitude may include: (i) obtaining a weighted sum of the criticality value and the similarity value and using the weighted sum as the change magnitude, (ii) using any other algorithm and/or calculation to obtain the change magnitude using the criticality value and the similarity value, and/or (iii) other methods.

The method may end following operation 324.

Turning to FIG. 3C, a third flow diagram illustrating a method for providing computer-implemented services using a data processing system in accordance with an embodiment is shown. The method may be performed, for example, by any of the components of the system of FIG. 1, and/or any other entity without departing from embodiments disclosed herein. The operations described in FIG. 3C may be an expansion of operation 304 shown in FIG. 3A.

At operation 330, a reviewing pipeline for the set of changes may be obtained, the reviewing pipeline indicating entities that are to perform portions of the review process, an ordering between the portions of the review process, and outcomes of the portions of the review process indicating whether the set of changes is to be integrated into the codebase. Obtaining the reviewing pipeline may include: (i) identifying, based on the subject for the at least the portion of the set of changes and/or the upstream dependencies, a portion of reviewers that are qualified to review the set of changes, (ii) selecting, based on at least reviewer characteristics for the reviewers and the change magnitude for the set of changes, at least one reviewer from the portion of reviewers for inclusion in the reviewing pipeline, (iii) reading the reviewing pipeline from storage, (iv) receiving the reviewing pipeline from another entity, and/or (v) other methods.

Identifying the portion of reviewers that are qualified to review the set of changes may include: (i) obtaining a reviewer database (e.g., a database, repository, list, and/or other type of data structure) including information regarding potential reviewers for the set of changes, (ii) performing a search in the reviewer database using the subject and/or the upstream dependencies as a key for the search to identify reviewers that are qualified to review the set of changes based on knowledge of the subject and/or the upstream dependencies, (iii) selecting the portion of reviewers from the identified reviewers, and/or (iv) other methods. In doing so, the potential reviewers may be filtered by knowledge base (e.g., knowledge of the subject and/or upstream dependencies) to obtain the portion of the reviewers.

Selecting the at least one reviewer from the portion of reviewers for inclusion in the reviewing pipeline may include: (i) identifying, based on the change characteristics, entity characteristics for the entity, and a reviewer rule set, reviewer requirements for the set of changes, (ii) selecting, from the portion of reviewers and based on the reviewer characteristics, the at least one reviewer that meets the reviewer requirements for the set of changes, (iii) providing the portion of reviewers to another entity and receiving an indication of the at least one reviewer in response, and/or (iv) other methods.

Identifying the reviewer requirements for the set of changes may include: (i) obtaining the entity characteristics for the entity, (ii) obtaining the reviewer rule set (e.g., receiving the reviewer rule set from a management entity responsible for managing integration of sets of changes into codebases, reading the reviewer rule set from storage, generating the reviewer rule set), (iii) performing a lookup in a lookup table included in the reviewer rule set using the entity characteristics and/or the change characteristics as a key for the lookup to obtain the reviewer requirements, (iv) receiving the reviewer requirements from another entity, and/or (v) other methods. Identifying the reviewer requirements may also include: (i) obtaining a score for the set of changes using a scoring system and based on the entity characteristics and/or the change characteristics, and/or (ii) performing the lookup in the lookup table included in the reviewer rule set using the score as the key for the lookup to obtain the reviewer requirements.

Obtaining the entity characteristics for the entity may include: (i) reading metadata including the entity characteristics included in the set of changes, (ii) reading the entity characteristics from storage (e.g., from a database used to store information regarding entities), (iii) receiving the entity characteristics in a message from the entity, (iv) receiving the entity characteristics from another entity, and/or (v) other methods.

Selecting the at least one reviewer that meets the reviewer requirements for the set of changes may include: (i) performing a lookup in a lookup table included in the reviewer database using the reviewer requirements as a key for the lookup, (ii) identifying, based on a result of the lookup, the at least one reviewer that meets the reviewer requirements for the set of changes, (iii) providing the reviewer requirements to another entity and receiving the at least one reviewer that meets the reviewer requirements in response, and/or (iv) other methods.

At operation 332, review of the set of changes using the reviewing pipeline may be initiated to obtain the outcomes, the outcomes indicating whether corresponding portions of the source code as modified by the set of changes meet functional specification requirements for the updated version of the software program. Initiating the review of the set of changes may include: (i) providing the set of changes to the first reviewer indicated by the reviewing pipeline, (ii) if an outcome obtained from the first reviewer indicates that the set of changes meets the functional specification requirements: providing the set of changes to the second reviewer indicated by the reviewing pipeline, (iii) continuing provision of the set of changes to the reviewers indicated by the reviewing pipeline until outcomes are obtained from each of the reviewers and/or an outcome indicates that the set of changes does not meet the functional specification requirements, and/or (iv) other methods. Initiating review of the set of changes may also include: (i) providing the set of changes to the reviewers indicated by the reviewing pipeline to obtain the outcomes, and/or (ii) aggregating the outcomes to obtain a result (e.g., via averaging the outcomes and/or using any other method to aggregate the outcomes to obtain the result), the result indicating whether the set of changes meets the functional specification requirements.

At operation 334, it may be determined whether to integrate the set of changes into the codebase using the outcomes. Making the determination may include: (i) reading the outcomes and/or the result (e.g., obtained by aggregating the outcomes) to determine whether the outcomes and/or the result indicates the set of changes meets the functional specification requirements, (ii) concluding, if the set of changes meets the functional specification requirements, that the set of changes is to be integrated into the codebase, (iii) concluding, if the set of changes does not meet the functional specification requirements, that the set of changes is not to be integrated into the codebase, (iv) providing the outcomes to another entity and receiving the determination in response, (v) providing the outcomes to an SME responsible for making the determination based on the outcomes, and/or (vi) other methods.

The method may end following operation 334.

Thus, as illustrated above, embodiments disclosed herein may provide systems and methods usable to manage integration of sets of changes into codebases for software programs in a manner that reduces a likelihood of negatively impacting the software programs. Consequently, computer-implemented services provided using the software programs may be provided as desired by downstream consumers of the computer-implemented services.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows^{®}operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using a data processing system, the method comprising:
obtaining a set of changes for a codebase from an entity, the codebase comprising source code for a software program, and the set of changes comprising potential changes to the source code usable to obtain an updated version of the software program;
performing, using the set of changes, an analysis process to obtain change characteristics for the set of changes, the change characteristics comprising:
a change magnitude for the set of changes,
a subject for at least a portion of the set of changes, and
upstream dependencies for functionalities of the software program that would be modified should the set of changes be integrated into the codebase;
performing a review process for the set of changes to determine whether the set of changes is to be integrated into the codebase, the review process being based on the change characteristics; and
in a first instance of the performing in which the set of changes is to be integrated into the codebase:
performing an integration process to obtain the updated version of the software program to continue provision of the computer-implemented services.

2. The method of claim 1, wherein performing the review process comprises:
obtaining a reviewing pipeline for the set of changes, the reviewing pipeline indicating entities that are to perform portions of the review process, an ordering between the portions of the review process, and outcomes of the portions of the review process indicating whether the set of changes is to be integrated into the codebase.

3. The method of claim 2, wherein performing the review process comprises:
initiating review of the set of changes using the reviewing pipeline to obtain the outcomes, the outcomes indicating whether corresponding portions of the source code as modified by the set of changes meet functional specification requirements for the updated version of the software program; and
determining whether to integrate the set of changes into the codebase using the outcomes.

4. The method of claim 2, wherein obtaining the reviewing pipeline comprises:
identifying, based on the subject for the at least the portion of the set of changes and/or the upstream dependencies, a portion of reviewers that are qualified to review the set of changes; and
selecting, based on at least reviewer characteristics for the reviewers and the change magnitude for the set of changes, at least one reviewer from the portion of reviewers for inclusion in the reviewing pipeline.

5. The method of claim 4, wherein selecting the at least one reviewer comprises:
identifying, based on the change characteristics, entity characteristics for the entity, and a reviewer rule set, reviewer requirements for the set of changes; and
selecting, from the portion of reviewers and based on the reviewer characteristics, the at least one reviewer that meets the reviewer requirements for the set of changes.

6. The method of claim 5, wherein a higher change magnitude indicates integrating the set of changes into the codebase has an increased risk of undesired impacts on the updated version of the software program, and mitigating the increased risk of undesired impacts results in a larger resource consumption to meet the reviewer requirements.

7. The method of claim 5, wherein the at least one reviewer comprises a team of reviewers that, in aggregate, meets the reviewer requirements for the set of changes, and the team of reviewers comprises at least one subject matter expert.

8. The method of claim 7, wherein the team of reviewers comprises at least one fully automated entity.

9. The method of claim 4, wherein the reviewer characteristics comprise at least one type of characteristic selected from a list consisting of:
reviewer job ranking;
reviewer experience level; and
reviewer area of expertise.

10. The method of claim 1, wherein performing the analysis process comprises:
performing a first analysis process to obtain the change magnitude for the set of changes, the change magnitude indicating a level of change to the source code should the set of changes be integrated into the codebase;
performing a second analysis process to obtain the subject for the at least a portion of the set of changes; and
performing a third analysis process to obtain the upstream dependencies for the functionalities of the software program that would be modified should the set of changes be integrated into the codebase.

11. The method of claim 10, wherein performing the first analysis process comprises:
obtaining, using the set of changes and the codebase, a criticality value for the set of changes,
obtaining, using the set of changes and the codebase, a similarity value for the set of changes; and
obtaining, using at least the criticality value and the similarity value, the change magnitude.

12. The method of claim 11, wherein obtaining the criticality value comprises:
evaluating a degree of impact of integrating the set of changes into the codebase, the degree of impact being based on a number of application programming interfaces (APIs) impacted by the set of changes; and
assigning, based on the degree of impact, the criticality value.

13. The method of claim 11, wherein obtaining the similarity value comprises:
obtaining, using the set of changes and a trained machine learning model, a first summary of the set of changes and a second summary of at least a portion of the source code that would be impacted by integrating the set of changes into the codebase;
comparing the first summary and the second summary to obtain a difference; and
assigning, based on the difference, the similarity value.

14. The method of claim 11, wherein the change magnitude is a weighted sum of the criticality value and the similarity value.

15. A non-transitory machine-readable medium having instructions stored therein, which when executed by a processor, cause the processor to perform operations for providing computer-implemented services using a data processing system, the operations comprising:
obtaining a set of changes for a codebase from an entity, the codebase comprising source code for a software program, and the set of changes comprising potential changes to the source code usable to obtain an updated version of the software program;
performing, using the set of changes, an analysis process to obtain change characteristics for the set of changes, the change characteristics comprising:
a change magnitude for the set of changes,
a subject for at least a portion of the set of changes, and
upstream dependencies for functionalities of the software program that would be modified should the set of changes be integrated into the codebase;
performing a review process for the set of changes to determine whether the set of changes is to be integrated into the codebase, the review process being based on the change characteristics; and
in a first instance of the performing in which the set of changes is to be integrated into the codebase:
performing an integration process to obtain the updated version of the software program to continue provision of the computer-implemented services.

16. The non-transitory machine-readable medium of claim 15, wherein performing the review process comprises:
obtaining a reviewing pipeline for the set of changes, the reviewing pipeline indicating entities that are to perform portions of the review process, an ordering between the portions of the review process, and outcomes of the portions of the review process indicating whether the set of changes is to be integrated into the codebase.

17. The non-transitory machine-readable medium of claim 16, wherein performing the review process comprises:
initiating review of the set of changes using the reviewing pipeline to obtain the outcomes, the outcomes indicating whether corresponding portions of the source code as modified by the set of changes meet functional specification requirements for the updated version of the software program; and
determining whether to integrate the set of changes into the codebase using the outcomes.

18. A data processing system, comprising:
a processor; and
a memory coupled to the processor to store instructions, which when executed by the processor, cause the processor to perform operations for providing computer-implemented services using a data processing system, the operations comprising:
obtaining a set of changes for a codebase from an entity, the codebase comprising source code for a software program, and the set of changes comprising potential changes to the source code usable to obtain an updated version of the software program;
performing, using the set of changes, an analysis process to obtain change characteristics for the set of changes, the change characteristics comprising:
a change magnitude for the set of changes,
a subject for at least a portion of the set of changes, and
upstream dependencies for functionalities of the software program that would be modified should the set of changes be integrated into the codebase;
performing a review process for the set of changes to determine whether the set of changes is to be integrated into the codebase, the review process being based on the change characteristics; and
in a first instance of the performing in which the set of changes is to be integrated into the codebase:
performing an integration process to obtain the updated version of the software program to continue provision of the computer-implemented services.

19. The data processing system of claim 18, wherein performing the review process comprises:
obtaining a reviewing pipeline for the set of changes, the reviewing pipeline indicating entities that are to perform portions of the review process, an ordering between the portions of the review process, and outcomes of the portions of the review process indicating whether the set of changes is to be integrated into the codebase.

20. The data processing system of claim 19, wherein performing the review process comprises:
initiating review of the set of changes using the reviewing pipeline to obtain the outcomes, the outcomes indicating whether corresponding portions of the source code as modified by the set of changes meet functional specification requirements for the updated version of the software program; and
determining whether to integrate the set of changes into the codebase using the outcomes.
